(19) United States
(12) Patent Application Publication
(10) Pub. No.: US 2007/0086519 A1
(43) Pub. Date: Apr. 19, 2007

(54) Apparatus for managing multipurpose video streaming and method of the same

(75) Inventor: Jeong-eun Lim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/545,569

(22) Filed: Oct. 11, 2006

(30) Foreign Application Priority Data
Oct. 17, 2005 (KR) 2005-0097588

(51) Int. Cl. H04B 1/66; H04N 7/12

(52) U.S. Cl. 375/240.1; 375/240.26

(57) ABSTRACT

Provided is an apparatus for managing multipurpose video streaming and a method of the same, which are capable of creating high-resolution video frames for displaying and storing received video data in real time and low-resolution video frames for network transmission, and managing the created video stream. The apparatus for managing mulitpurpose video streaming includes an encoding unit for creating and outputting video frames including at least one of high-resolution video frames and low-resolution video frames with respect to video data; and a path determining unit for identifying the at least one of high-resolution video frames and low-resolution video frames in the output video frames and for determining a process path such that the high-resolution video frames are stored and the low-resolution video frames are transmitted.

### CROSS-REFERENCE TO RELATED APPLICATION

This application claims the benefit under 35 U.S.C. §119(a) of Korean Patent Application No. 10-2005-097588, filed on Oct. 17, 2005, in the Korean Intellectual Property Office, the entire disclosure of which is hereby incorporated by reference.

### BACKGROUND OF THE INVENTION

1. Field of the Invention

The present invention relates to an apparatus for managing multipurpose video streaming and a method of the same. More particularly, the present invention relates to an apparatus for managing multipurpose video streaming and a method of the same, which are capable of creating a high-resolution video stream for displaying and storing received video data in real time and a low-resolution video stream for network transmission, and managing the crated video stream.

2. Description of the Related Art

As information communication technologies evolve, the use of information communication technologies continues to increase. Exemplary information communication technologies include the Internet, video communications, text communications and voice communications. Conventional text communications fall short of satisfying users' various demands. Thus, multimedia services are increasingly used that provide various types of information, such as text, pictures, and music. However, multimedia data comprises large amounts of data and therefore requires a lot of bandwidth for transmission. Accordingly, a compression coding method is required for transmitting multimedia data including text, video, and audio.

A digital video recorder (DVR) is typically used as a monitoring system for storing, searching, and managing digital moving pictures. As high-speed information communication networks evolve various video materials comprising large amounts of data will increasingly be circulated. Accordingly, it is anticipated that the DVR technology will become increasingly important.

With the increasing importance of DVR technology, compression coding methods have become important for multimedia content, including digital video. MPEG-4 (Motion Picture Experts Group-4) is a multimedia information compression coding method that is used for monitoring high-definition video in various environments, and for one-way transmission and two-way transmission. Further, since security equipment is being increasingly converted into a digital format, users can monitor multimedia content transmitted through the Internet in real-time.

FIG. 1 is a diagram illustrating a conventional digital video managing apparatus. This digital video managing apparatus includes an encoding unit 10, a communication unit 110, a storage unit 120, and a display unit 130.

The encoding unit 10 serves to compress a digital video stream received through a camera or the like. In this case, the encoding unit 10 may have a plurality of encoders 11, 12, 13, and 14. Accordingly, the encoding unit 10 can simultaneously encode digital video streams that are received from the plurality of cameras.

The digital video stream, which is encoded by the encoding unit 10, is transmitted to the communication unit 110 and the storage unit 120. The communication unit 110 serves to transmit the digital video stream received from the encoding unit 10 through a network. The storage unit 120 serves to store the digital video stream received from the encoding unit. The display unit 130 serves to display the digital video stream received from the encoding unit 10.

That is, the same digital video stream, which is encoded by the encoding unit 10, is transmitted through the network, stored in the storage unit 120, or displayed on the display unit 130.

However, the data transmission through the network is dependent on bandwidth. Preferably the digital video stream encoded by the encoding unit 10 is not transmitted through the network as it is. That is, it is preferable that a size of the digital video stream transmitted through the network be smaller than that of the displayed or stored digital video stream.

FIG. 2 is a diagram illustrating a conventional digital video managing apparatus, which illustrates a digital video managing apparatus including an encoding unit 20 that has encoders 21 to 28 for performing different functions.

The encoding unit 20 of the digital video managing apparatus shown in FIG. 2 includes encoders 21, 23, 25, and 27 for network transmission and encoders 22, 24, 26, and 28 for display or storage. The digital video for network transmission is restricted to a smaller size than the digital video for display or storage. Therefore, the encoders for network transmission 21, 23, 25, and 27 compress the data transmitted from the camera with a higher compression rate than in the encoders for display or storage 22, 24, 26, and 28.

Accordingly, the digital video stream transmitted through the network can be transmitted through the communication unit 210 using relatively little bandwidth, and the displayed or stored digital video stream can be displayed on the display unit 230 or stored in the storage unit 220 using a lower compression rate and having a higher resolution.

However, the encoding unit 20 of FIG. 2 utilizes twice as many encoders than are used in encoding unit 10 of FIG. 1. The additional encoders result in an increase in an operational load of a central processing unit (CPU).

Accordingly, there is a need for a method of creating high-resolution digital video streams and low-resolution digital video streams while not increasing the operation load of the CPU.

### SUMMARY OF THE INVENTION

Exemplary embodiments of the present invention address at least the above problems and/or disadvantages and provide at least the advantages described below. Accordingly, an aspect of the present invention is to provide an apparatus for creating or managing high-resolution video streams for displaying or storing received video data in real time and low-resolution video streams for network transmission and a method of the same.

The aspects of exemplary embodiments of the invention are not limited to the above-described aspects, and other aspects of the invention not described herein will become clear to those skilled in the art upon review of the following description.

According to an aspect of an exemplary embodiment of the invention, there is provided an apparatus for managing multipurpose video streaming. The apparatus for managing multipurpose video streaming includes encoding unit for creating and outputting video frames including at least one of high-resolution video frames and low-resolution video frames with respect to video data; and a path determining unit for identifying the at least one of high-resolution video frames and low-resolution video frames in the output video frames and for determining a process path such that the high-resolution video frames are stored and the low-resolution video frames are transmitted.

According to another aspect of an exemplary embodiment of the invention, there is provided a method of managing multipurpose video streaming. The method includes creating and outputting video frames including at least one of high-resolution video frames and low-resolution video frames with respect to video data, and identifying the at least one of high-resolution video frames and low-resolution video frames in the output video frames and determining a process path such that the high-resolution video frames are stored and the low-resolution video frames are transmitted.

According to yet another aspect of an exemplary embodiment of the invention, there is provided a computer-readable medium having embodied thereon a computer program for the method of managing multipurpose video streaming. The method includes creating and outputting video frames comprising at least one of high-resolution video frames and low-resolution video frames with respect to video data; and identifying the at least one of high-resolution video frames and low-resolution video frames in the output video frames and determining a process path such that the high-resolution video frames are stored and the low-resolution video frames are transmitted.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a diagram illustrating a conventional digital video managing apparatus;

FIG. 2 is a diagram illustrating a conventional digital video managing apparatus;

FIG. 3 is a block diagram illustrating an apparatus for managing multipurpose video streaming according to an exemplary embodiment of the invention;

FIG. 4 is a block diagram illustrating an encoder according to an exemplary embodiment of the invention.

FIG. 5 is a block diagram illustrating an encoder according to another exemplary embodiment of the invention;

FIG. 6 is a diagram illustrating divided video data according to an exemplary embodiment of the invention;

FIG. 7 is a diagram illustrating a path determining unit according to an exemplary embodiment of the invention; and

FIG. 8 is a flowchart illustrating a process for managing multipurpose video streaming according to an exemplary embodiment of the invention.

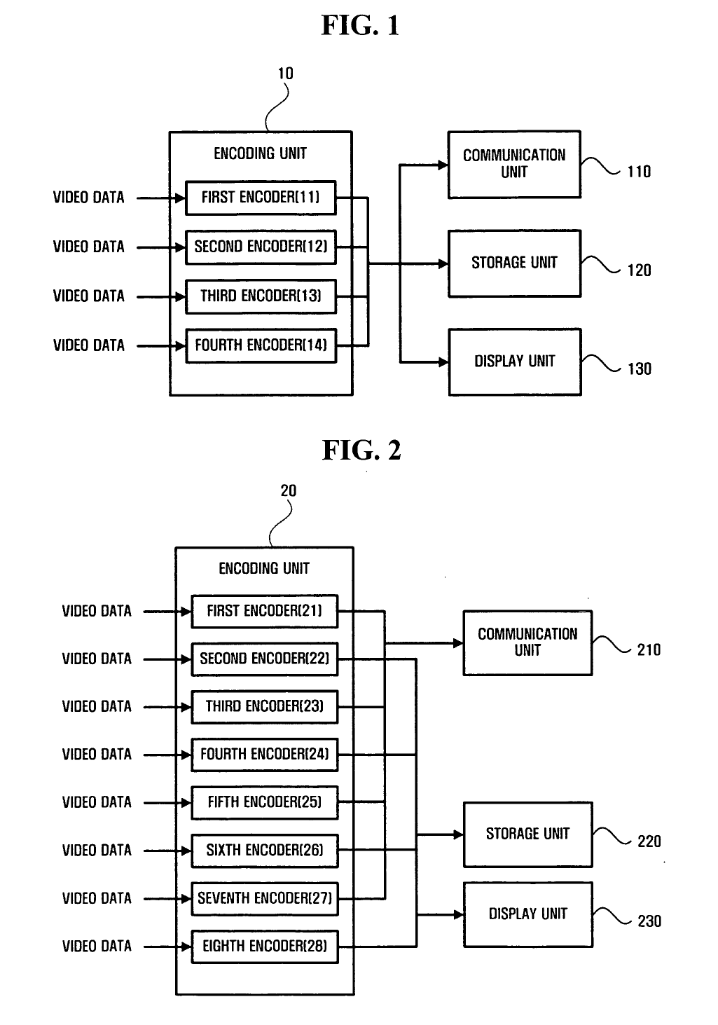

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention will now be described more fully with reference to the accompanying drawings. It is to be understood that blocks in the accompanying block diagrams and compositions of steps in flow charts can be performed by computer program instructions. These computer program instructions can be provided to processors of, for example, general-purpose computers, special-purpose computers, and programmable data processing apparatuses. Therefore, the instructions performed by the computer or the processors of the programmable data processing apparatus generate means for executing functions described in the blocks in block diagrams or the steps in the flow charts. The computer program instructions can be stored in a computer available memory or a computer readable memory of the computer or the programmable data processing apparatus in order to realize the functions in a specific manner. Therefore, the instructions stored in the computer available memory or the computer readable memory can manufacture products including the instruction means for performing the functions described in the blocks in the block diagrams or the steps in the flow charts. Also, the computer program instructions can be loaded onto the computer or the computer programmable data processing apparatus. Therefore, a series of operational steps is performed in the computer or the programmable data processing apparatus to generate a process executed by the computer, which makes it possible for the instructions driving the computer or the programmable data processing apparatus to provide steps of executing the functions described in the blocks of the block diagrams or the steps of the flow charts.

Each block or each step may indicate a portion of a code, a module, or a segment including one or more executable instructions for performing a specific logical function (or functions). It should be noted that, in some modifications of the exemplary embodiments of the invention, the functions described in the blocks or the steps may be generated out of order. For example, two blocks or steps continuously shown can be actually performed at the same time, or they can be performed sometimes in reverse order according to the corresponding functions.

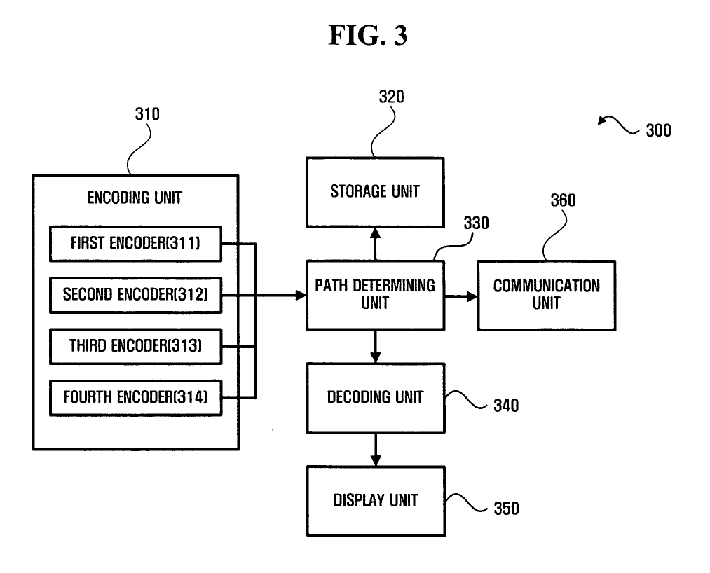

FIG. 3 is a block diagram illustrating an apparatus for managing multipurpose video streaming according to an exemplary embodiment of the invention. The apparatus for managing multipurpose video streaming 300 (hereinafter, referred to as apparatus) includes an encoding unit 310, a storage unit 320, a path determining unit 330, a decoding unit 340, a display unit 350, and a communication unit 360.

In a case in which the received video data is stored or displayed, if there is sufficient storage capacity in storage unit 320 and display unit 350 has sufficient display capabilities, a user can store or display high-definition video data. In the meantime, in a case in which the received video data is transmitted through a network, if sufficient network bandwidth is not ensured, the user cannot transmit high-definition video data.

Therefore, when the received video data is stored or displayed, the apparatus 300 stores or displays the received video data in a state in which it substantially maintains the characteristics of the original received video data. When the received video data is transmitted through a network, the apparatus 300 converts the original received video data so as to reduce its amount of data, and then transmits the reduced video data. That is, the apparatus 300 performs different processes with respect to the same video data, depending what is to be done with the video data.

The encoding unit 310 includes one or more encoders 311 to 314. The encoding unit 310 creates high-resolution video frames and low-resolution video frames with respect to the received video data, and outputs the high-resolution video frames and the low-resolution video frames in the order they are created. That is, the encoding unit 310 encodes the video frames with high-resolution video frames such that the characteristics of the original video data is substantially maintained and low-resolution video frames which have been converted into a data size capable of being transmitted through the network.

For this encoding process, the encoding unit 310 can encode the received video data as is to create high-resolution video frames, and can sub-sample the received video data and then encode the received video data to create low-resolution video frames.

In addition, the encoding unit 310 can compress each of a plurality of received video data with a different data compression rate. That is, the encoding unit 310 can compress the received video data with a relatively low compression rate to create high-resolution video frames, and can compress the received video data with a relatively high compression rate to create low-resolution video frames.

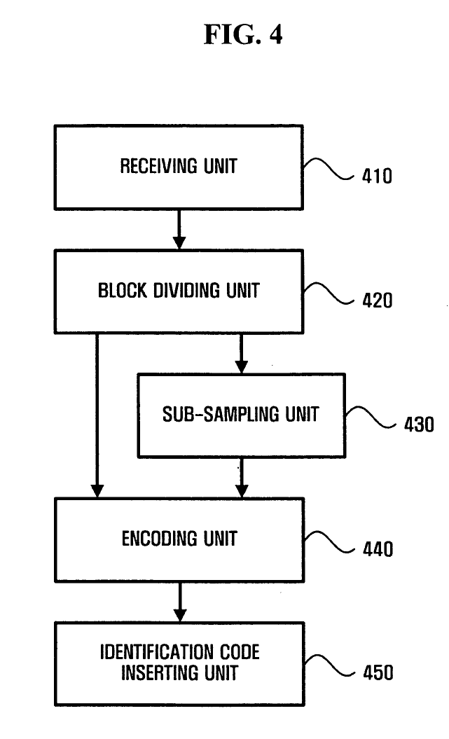

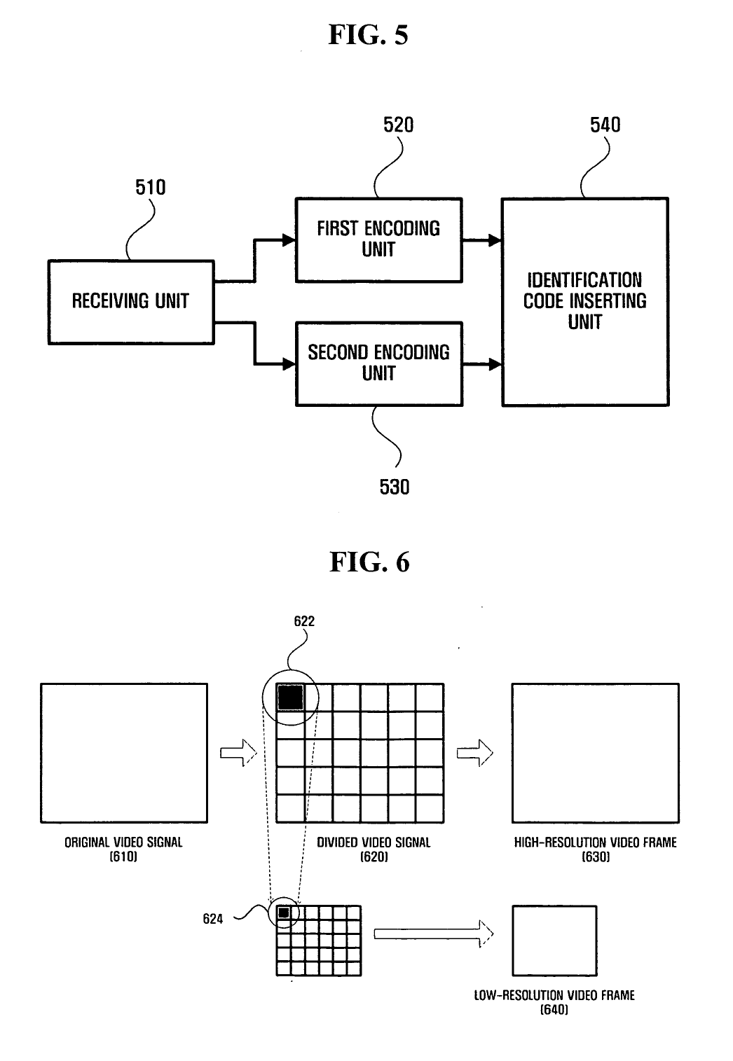

As a method of encoding data by using the encoding unit 310, MPEG-4 is preferable. However, in exemplary embodiments of the present invention, a method of encoding data by the encoding unit 310 is not limited thereto, and other video encoding methods, such as MPEG-1, MPEG-2, MPEG-7, MPEG-21, H263, H264, or the like, may be used to encode the received video data. The detailed description of the encoders 311 to 314 will be made below with reference to FIGS. 4 and 5.

The path determining unit 330 identifies the types of video frames output from the encoding unit 310, and determines a process path such that high-resolution video frames are stored or displayed and low-resolution video frames are transmitted. In this case, the path determining unit 330 can determine a process path by using identification codes included in the video frames output from the encoding unit 310. For this reason, when the encoding unit 310 creates high-resolution video frames or low-resolution video frames, it can insert identification codes for the high-resolution video frames and identification codes for the low-resolution video frames.

The communication unit 360 serves to transmit the low-resolution video frames. That is, the communication unit 360 transmits the video data having a relatively small size. Examples of a communication method used by the communication unit 360 may include wireless communication methods like blue-tooth, home RF, and wireless LAN as well as a wire communication method like Ethernet.

The storage unit 320 serves to store high-resolution video frames. That is, the storage unit 320 stores the received video frames such that it substantially maintains the characteristics of the received original video data.

The storage unit 320 is a module, such as a hard disk, a flash memory, a CF card (Compact Flash Card), an SD card (Secure Digital Card), an SM card (Smart Media Card), an MMC card (Multimedia Card) or a memory stick, which can input or output information. The storage unit 320 may be included in the apparatus 300 or may be included in a separated device.

Further, the apparatus 300 may further include the display unit 350 that displays the high-resolution video frames. The display unit 350 is a module that includes a video display unit, such as a cathode ray tube (CRT), a liquid crystal display (LCD), a light-emitting diode (LED), an organic light-emitting diode (OLED) or a plasma display panel (PDP), which can display a video signal. The display unit 350 serves to display the transmitted video information.

In order to display the high-resolution video frames through the display unit 350, the apparatus 300 may be provided with the decoding unit 340 for decoding the encoded high-resolution video frame.

FIG. 4 is a block diagram illustrating an encoder according to an exemplary embodiment of the invention. Each of the encoders 311 to 314 includes a receiving unit 410, a block dividing unit 420, a sub-sampling unit 430, an encoding unit 440, and an identification code inserting unit 450.

The receiving unit 410 serves to receive the video data. In this case, the received video data may be data received from a camera, data received from a separate device that stores video data, or data that is received through a network.

In addition, it is preferable that the video data received by the receiving unit 410 be video data that has been subjected to proper preprocessing like analog to digital (A/D) converting such that the encoding unit 310 encodes the received video data.

The block dividing unit 420 serves to divide the video data received from the receiving unit 410 into blocks of select sizes.

As a method of preventing video from overlapping one another, there is a method of assuming and compensating motion for each block. That is, dividing a screen into unit screens having select sizes and calculating a motion vector indicating whether each unit screen has moved from any location of a front screen in order to compensate for motion. In this case, a screen block, which is obtained by dividing one screen into a select size, is referred to as a macro block. The macro block includes four blocks, each of which is composed of 8×8 sub-blocks, that is, a block composed of 16×16 sub-blocks.

A video compression algorithm, such as H.261 and MPEG, compresses the original video data using motion compensation through the above-described macro block. The block dividing unit 420 divides the received video data into the macro blocks.

The sub-sampling unit 430 serves to sub-sample the respective blocks that are divided by the block dividing unit 420. In this case, a sub-sampling ratio can be determined by a user. If the sub-sampling unit 430 has a means for detecting a bandwidth of a network, the sub-sampling unit 430 can sub-sample the blocks to correspond to the detected network bandwidth.

The encoding unit 440 encodes the blocks to create high-resolution video frames, and encodes the sub-sampled blocks to create low-resolution video frames. That is, the encoding unit 440 performs a compression process for blocks. As compression methods, as described above, MPEG-1, MPEG-2, MPEG-4, MPEG-7, MPEG-21, H.263, H.264, or the like may be used.

The encoding unit 440 encodes the blocks divided by the block dividing unit 420 and the blocks sampled by the sub-sampling unit 430. In this case, the encoding unit 440 may simultaneously encode the respective blocks or may separately encode the respective blocks. In this case, when the encoding unit 440 separately encodes the respective blocks, the encoding unit 440 outputs an encoded block whenever each block is encoded. That is, the encoding unit 440 encodes the respective blocks in an arbitrary order. The outputted encoded blocks are temporarily stored in a buffer (not shown), and if all blocks for one frame are stored, they are combined with each other as a high-resolution video frame or a low-resolution video frame.

The identification code inserting unit 450 serves to insert identification codes into the high-resolution video frame and the low-resolution video frame. The identification codes inserted into the high-resolution video frames may be different from the identification codes inserted into the low-resolution video frames. The identification codes may be inserted into all video frames that are transmitted from the encoding unit 440, and may insert the identification codes only when the respective type of the video frame transmitted from the encoding unit 440 has been converted.

FIG. 5 is a block diagram illustrating an encoder according to another exemplary embodiment of the invention. Each of the encoders 311 to 314 includes a receiving unit 510, a first encoding unit 520, a second encoding unit 530, and an identification code inserting unit 540.

The receiving unit 510 serves to receive the video data. In this case, the received video data may be data received from a camera, data received from a separate device that stores video data, or data that is received through a network.

In addition, it is preferable that the video data received by the receiving unit 510 be video data that has been subjected to proper preprocessing like A/D converting such that the encoding unit 310 encodes the received video data.

The first encoding unit 520 serves to perform relatively low-level compression to create a video frame that substantially maintains the characteristics of the received video data. That is, the first encoding unit 520 serves to create high-resolution video frames.

The second encoding unit 530 serves to perform relatively high-level compression so as to create small-sized video frames. That is, the second encoding unit 530 serves to create low-resolution video frames.

In this case, the first encoding unit 520 can encode the received video data with a different compression rate in accordance with a user's instruction or a storage capacity of the storage unit 320. The second encoding unit 530 can encode the received video data in accordance with an available bandwidth of the network.

The first encoding unit 520 and the second encoding unit 530 may be provided as separated encoding units as shown in FIG. 5, or may be integrated with each other as one encoding unit. In a case in which the first encoding unit 520 and the second encoding unit 530 are integrated with each other as one encoding unit, one encoding unit may alternately perform high-level compression and low-level compression with respect to the video data transmitted from the receiving unit 510.

The high-resolution video frame and the low-resolution video frame, which are respectively created by the first encoding unit 520 and the second encoding unit 530, are transmitted to an identification code inserting unit 540, and the identification code inserting unit 540 inserts identification codes into the high-resolution video frame and the low-resolution video frame. The high-resolution video frame and the low-resolution video frame, which are respectively created by the first encoding unit 520 and the second encoding unit 530, may not necessarily be transmitted to the identification code inserting unit 540 in the order they are created. Therefore, the identification code inserting unit 540 may insert identification codes into all video frames that are transmitted from the first encoding unit 520 and the second encoding unit 530, and may insert identification codes only when the respective types of the transmitted video frames has been converted.

FIG. 6 is a diagram illustrating divided video data according to an exemplary embodiment of the invention.

If the receiving unit 410 of the encoder receives the original video data 610, the received original video data 610 is transmitted to the block dividing unit 420. In the block dividing unit 420, the original video data 610 is divided into blocks 622 so as to become divided video data 620. In this case, the block 622 includes at least one macro block.

The respective original blocks 622 are transmitted to the sub-sampling unit 430 so as to be subjected to the sub-sampling process, and the sub-sampled blocks 624 are temporarily stored in a buffer. Then, the sub-sampled blocks 624 and the original blocks 622 that are included in the divided video data 620 are encoded by the encoding unit 440. If the original blocks 622 are completely encoded, they form a high-resolution video frame 630. If the sub-sampled blocks 624 are completely encoded, they form a low-resolution video frame 640.

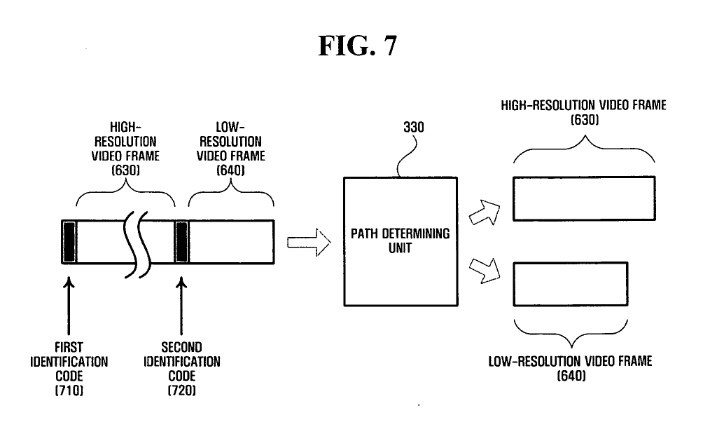

FIG. 7 is a diagram illustrating a path determining unit according to an exemplary embodiment of the invention. The path determining unit 330 determines process paths for a high-resolution video frame 630 and a low-resolution video frame 640 that are output from the encoding unit 310.

The video frames that are output from the encoding unit 310 correspond to video frames 640 in which high-resolution video frames 630 and low-resolution video frames 640 are mixed among one another. In this case, since the high-resolution video frames 630 and the low-resolution video frames 640 are randomly mixed among each other, the path determining unit 330 identifies the types of the video frames by using the identification codes 710 and 720 that are inserted into the respective video frames. That is, the path determining unit 330 confirms the types of the video frames by using an identification code 710 (hereinafter, referred to as first identification code) that is inserted into the high-resolution video frame 630 and an identification code 720 (hereinafter, referred to as a second identification code) that is inserted into the low-resolution video frame 640.

The first identification code 710 and the second identification code 720 are preferably inserted into the beginning of the video frames 630 and 640. If the output video frame is converted, the encoding unit 310 may insert the first identification code 710 or the second identification code 720. Therefore, the path determining unit 330 assumes that the video frames are same type until video frames having the first identification code 710 or the second identification code 720 inserted are transmitted.

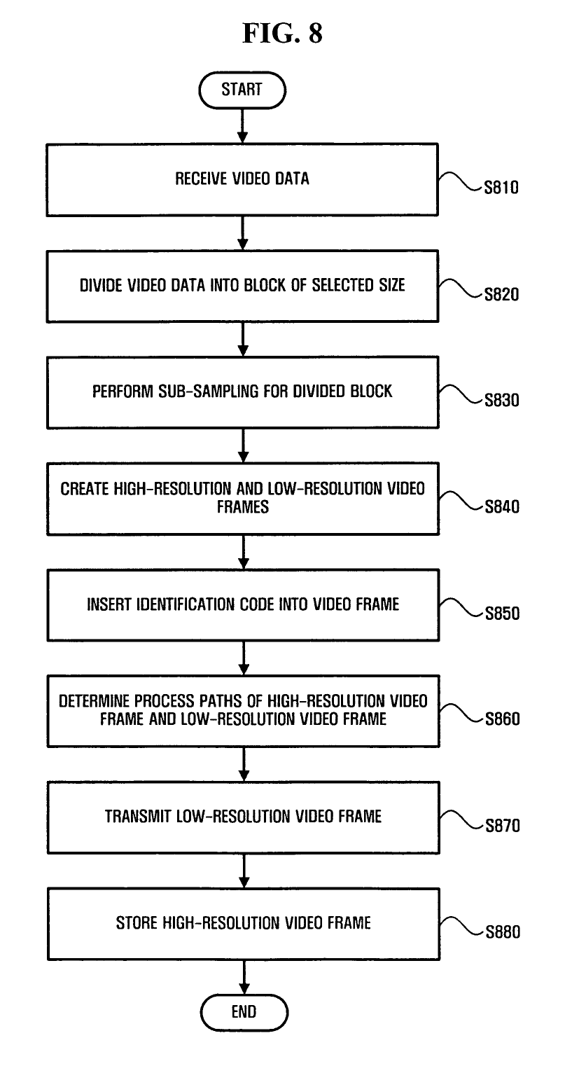

FIG. 8 is a flowchart illustrating a process for managing a multipurpose video stream according to an exemplary embodiment of the invention.

In order to process the multipurpose video stream, first, the receiving unit 410 of the apparatus 300 receives the video data (S810). In this case, the received video data may be data received from a camera, data received from a separate device which stores the video data, and data received through a network.

The received data is transmitted to the block dividing unit 420 of the encoding unit 310, and the block dividing unit 420 divides the transmitted video data into blocks having select sizes (S820). In this case, the block may be a macro block which is used in a general compression algorithm for video data.

The divided blocks are transmitted to the sub-sampling unit 430, and the sub-sampling unit 430 performs sub-sampling on the transmitted blocks (S830). In this case, a sub-sampling ratio may be determined in accordance with a user's instruction and may be automatically determined in accordance with a bandwidth of the network.

The blocks divided by the block dividing unit 420 and the blocks sub-sampled by the sub-sampling unit 430 are transmitted to the encoding unit 440. Then, the encoding unit 440 encodes the blocks transmitted directly from the block dividing unit 420 to create a high-resolution video frame, and encodes the sub-sampled blocks to create a low-resolution video frame (S840).

The created high-resolution video frame and low-resolution video frame are transmitted to the identification code inserting unit 450, and the identification code inserting unit 450 inserts a unique identification code into the transmitted video frames (S850). The high-resolution video frame and the low-resolution video frame in which the identification codes are inserted may be transmitted to the path determining unit 330 in an arbitrary order. The path determining unit 330 determines a process path of a high-resolution video frame and a process path of a low-resolution video frame such that video frames are stored or transmitted in accordance with types of the transmitted video frames (S860). In this case, the path determining unit 330 may determine the process path by using the identification code included in the transmitted video frame.

The low-resolution video frames of the video frames, which are output in accordance with the determined paths, are transmitted to the communication unit 360, and the communication unit 360 transmits the received low-resolution video frames (S870).

In addition, the high-resolution video frames of the video frames, which are output in accordance with the determined paths, are transmitted to the storage unit 320 so as to be stored therein (S880).

Further, if the apparatus 300 includes a display unit 350, the high-resolution video frame is transmitted to the display unit 350 so as to be displayed. At this time, the high-resolution video frame is decoded by the decoding unit 340, and then transmitted to the display unit 350.

The apparatus for managing multipurpose video streaming according to exemplary embodiments of the present invention and a method of the same can achieve the following effects.

According to one effect of the exemplary embodiments of prevention invention, it is possible to simultaneously create and manage a high-resolution video stream for displaying and storing received video data in real time and a low-resolution video stream for network transmission.

According to another effect of the exemplary embodiments of present invention, it is possible to prevent an operational load of a central processing unit from increasing by creating high-resolution and low-resolution video streams through one encoder.

While certain exemplary embodiments of the invention has have been shown and described hereinwith reference to a certain preferred embodiments thereof, it will be understood by those skilled in the art that various changes in form and details may be made therein without departing from the spirit and scope of the invention as defined by the appended claims and their equivalents.

What is claimed is:

1. An apparatus for managing video streaming, comprising:
an encoding unit for creating and outputting video frames comprising at least one of high-resolution video frames and low-resolution video frames with respect to video data; and
a path determining unit for identifying the at least one of high-resolution video frames and low-resolution video frames in the output video frames and for determining a process path such that the high-resolution video frames are stored and the low-resolution video frames are transmitted.

2. The apparatus of claim 1, wherein the encoding unit includes:
a receiving unit for receiving the video data;
a block dividing unit for dividing the video data into blocks of select sizes;
a sub-sampling unit for sub-sampling the blocks;
an encoding unit for encoding the blocks to create the high-resolution video frames and for encoding the sub-sampled blocks to create the low-resolution video frames; and
an identification code inserting unit for inserting identification codes into the high-resolution video frames and the low-resolution video frames.

3. The apparatus of claim 2, wherein the identification codes are inserted at the beginning of the output video frames.

4. The apparatus of claim 1, wherein the encoding unit includes:
a receiving unit for receiving the video data;
a first encoding unit for encoding the received video data to create the high-resolution video frames;
a second encoding unit for encoding the received video to create the low-resolution video frames; and
an identification code inserting unit for inserting identification codes into the high-resolution video frames and the low-resolution video frames.

5. The apparatus of claim 4, wherein the identification codes are inserted at the beginning of the output video frames.

6. The apparatus of claim 1, wherein the path determining unit determines the process path by using identification codes included in the output video frames.

7. The apparatus of claim 1, further comprising a storage unit for storing the high-resolution video frames.

8. The apparatus of claim 1, further comprising a display unit for displaying the high-resolution video frames.

9. The apparatus of claim 1, further comprising a communication unit for transmitting the low-resolution video frames.

10. The apparatus of claim 1, wherein the encoding unit outputs the high-resolution video frames and the low-resolution frames in the order they are created.

11. A method of managing video streaming, comprising:
creating and outputting video frames comprising at least one of high-resolution video frames and low-resolution video frames with respect to video data; and
identifying the at least one of high-resolution video frames and low-resolution video frames in the output video frames and determining a process path such that the high-resolution video frames are stored and the low-resolution video frames are transmitted.

12. The method of claim 11, wherein the creating of the output video frames includes:
receiving the video data;
dividing the video data into blocks of select sizes;
sub-sampling the blocks;
encoding the blocks to create the high-resolution video frames and encoding the sub-sampled blocks to create the low-resolution video frames; and
inserting identification codes into the high-resolution video frames and the low-resolution video frames.

13. The method of claim 12, wherein the identification codes are inserted at the beginning of the output video frames.

14. The method of claim 11, wherein the creating of the output video frames includes:
receiving the video data;
encoding the received video data to create the high-resolution video frames;
encoding the received video to create the low-resolution video frames; and
inserting identification codes into the high-resolution video frames and the low-resolution video frames.

15. The method of claim 14, wherein the identification codes are inserted at the beginning of the output video frames.

16. The method of claim 11, wherein in the identifying the at least one of high-resolution video frames and low-resolution video frames in the output video frames and the determining of the process path, the process path is determined by using identification codes included in the output video frames.

17. The method of claim 11, further comprising storing the high-resolution video frames.

18. The method of claim 11, further comprising displaying the high-resolution video frames.

19. The method of claim 11, further comprising transmitting the low-resolution video frames.

20. The method of claim 11, wherein the outputting of the high-resolution video frames and low-resolution video frames comprises outputting the high-resolution video frames and low-resolution video frames in the order they are created.

21. A computer-readable medium having embodied thereon a computer program for the method of managing video streaming, the method comprising:
creating and outputting video frames comprising at least one of high-resolution video frames and low-resolution video frames with respect to video data; and
identifying the at least one of high-resolution video frames and low-resolution video frames in the output video frames and determining a process path such that the high-resolution video frames are stored and the low-resolution video frames are transmitted.
